(19) United States
(12) Patent Application Publication
(10) Pub. No.: US 2006/0267803 A1
(43) Pub. Date: Nov. 30, 2006

(54) Non-perspective variable-scale map displays

(75) Inventors: Darrell L. Mathis, Menlo Park, CA (US); Tsia Kuznetsov, Cupertino, CA (US); Walter B. Zavoli, Palo Alto, CA (US)

Correspondence Address: FLIESLER MEYER, LLP, FOUR EMBARCADERO CENTER, SUITE 400, SAN FRANCISCO, CA, 94111, US

(73) Assignee: Tele Atlas North America, Inc., Lebanon, NH (US)

(21) Appl. No.: 11/440,329

(22) Filed: May 24, 2006

Related U.S. Application Data
(60) Provisional application No. 60/684,859, filed on May 26, 2005.

(51) Int. Cl. G08G 1/123

(52) U.S. Cl. 340/995.15

(57) ABSTRACT

Map displays have been an important element in the feature set of in-car navigation systems. Actually, with modem equipment extending such system functionality to personal digital assistants (PDAs) and cellular telephones, virtually all travelers may use and benefit from the present invention. Early digital displays were monochrome, single-line-vector, planar representations. Color, area fill, scale-dependent attribute selection, labeling, heading-up rotation, line thickness, signs and icons have all been added to make the display more informative and intuitive. Still today, the designer is challenged to provide a more informative, less distracting display to serve the multitasking driver. More recently, perspective view and 3D objects have gained popularity because of their added utility as well as aesthetic appeal. Just as the planar map is a special case of the perspective map, perspective is a special case of the variable-scale map. This disclosure offers some approaches to the use of non-perspective continuous variable-scale maps to solve inherent problems of more conventional navigation map displays.

### CLAIM OF PRIORITY

This application claims priority under 35 U.S.C. 119(e) to U.S. Provisional Patent Application No. 60/684,859, filed May 26, 2005, entitled “Non-Perspective Variable-Scale Map Displays,” by Darrell Mathis et al. (Attorney Docket No. TELA-07763US0), which application is incorporated herein by reference.

### FIELD OF THE INVENTION

This invention relates to digital images and, more particularly, to the display of digital images for navigation and other purposes.

### BACKGROUND OF THE INVENTION

The problem facing the navigation-map-display designer is that viewers require detailed maps in their immediate vicinities, in areas around their destinations and perhaps in other points of high interest. At the same time, viewers need those detailed maps in the contexts of smaller scale, less detailed maps showing their routes and the major roads and features extending out to their destinations and perhaps beyond. All this should ideally be displayed in a single map on a physically small screen.

FIG. 1A is a picture of a planar or fixed-scale map. This can be thought of as a perspective view where the eye of the viewer is above the ground (map) and looking straight down. This planar perspective view is depicted in FIG. 1B but for clarity the axes are rotated such that the central axis, y (green), remains vertical, the orthogonal axis, x (red), is going into the page and the point of view is located on the z axis (blue star), here plotted along the horizontal. The black grid is equivalent to the ground plane (GP) or map and the red grid is the projection plane (PP) where the map display would be viewed. While the viewer can get a good picture of the roads throughout the area, all features in a planar map are treated more or less with the same importance because they are all shown at the same scale. While the planar map is technically a perspective display where the viewing angle is orthogonal to the ground plane, by definition, it does not have a variable scale and so it is not further considered here.

FIG. 2A is a perspective view of the same map of FIG. 1A where the eye of the viewer is again above and looking down at the map but this time at a non-orthogonal angle. This is depicted in FIG. 2B where again the axes have been rotated to help in the visualization.

According to Southworth, M. et al. Maps. Little Brown and Company, Boston, 1982 (Southworth), angled-perspective paper maps have been in use for centuries and are particularly beneficial to the traveler. Digital versions of angled-perspective map displays are now incorporated in some in-car navigation systems as well as personal navigation devices. Actually, with modem equipment extending such system functionality to personal digital assistants (PDAs) and cellular telephones, virtually all travelers may use and benefit from the present invention. An angled-perspective view has the advantage of showing more detail (a larger scale) closer to the “view point” and less detail (with a smaller scale) at greater distances. In effect the scale is compressed by a given function at points further away from the vehicle.

However, an angled-perspective view is limited in how it depicts the road map. For example, the map is restricted to the inverse-to-distance scale compression law, which defines the change in scale along the central axis moving further away from the point of view. And the scale is fixed in the direction orthogonal to the central axis. Also, there are computational problems associated with points that fall near or behind the point of view (projected to the ground) and for points that fall near the horizon—especially when trying to compute inverse coordinates.

### SUMMARY OF THE INVENTION

These above problems can be eliminated and more functionality can be added by using non-perspective variable-scale projections to the display. This can increase its usability, especially for displays of the traveler's position.

From the map-display-designer point of view, the extra freedom supplied by a non-perspective variable-scale map allows for better designs. For one, there is no specific “point of view” required for the construction of such a map. Selection of scale functions can be made arbitrarily and independently along and orthogonal to the central axis. Also, different scaling functions can be applied in different areas of the map. For example, a magnifying “bubble” can be centered on the vehicle, as shown in FIG. 3.

U.S. Pat. No. 6,178,380 by Millington entitled “Street Identification for a Map Zoom of a Navigation System,” issued Jan. 23, 2001, discloses a vehicle location display for a navigation or route guidance system, providing information to a user regarding the current location of the vehicle on a map. Below, specific forms of non-perspective variable-scale maps that can be beneficially applied to the navigation map display will be described.

According to various embodiments of the invention, a method is disclosed for the non-perspective variable-scale display of a portion of topographic information, comprising: a) maintaining a data structure of topographic information; b) selecting from the data structure a portion of the topographic information for display; c) performing a coordinate transformation of the selected topographic information to represent the selected information as a variable-scale map other than a perspective map; and d) displaying the selected transformed topographic information as a non-perspective variable-scale image.

According to other embodiments of the invention, an apparatus is disclosed for the non-perspective variable-scale topographic display of successive images comprising: a memory for the storage of topographic coordinate information, first selection means for selecting topographic sub-information from the topographic information by performing at least a first selection operation, transformation means for performing a coordinate transformation on the selected sub-information, and display means for the display of a non-perspective variable-scale image produced by the transformation.

According to other embodiments of the invention, a method is disclosed for the non-perspective variable-scale display of a portion of topographic information including a portion corresponding to a path that a traveler is capable of traveling, comprising: a) maintaining a data structure of topographic information; b) selecting from the data structure a portion of the topographic information for display dependent on a current position of the traveler; c) performing a coordinate transformation of the selected topographic information to represent the selected information as a variable-scale map other than a perspective map; and d) displaying the selected transformed topographic information as a non-perspective variable-scale image.

According to further embodiments of the invention, a method is disclosed for the non-perspective variable-scale display of a portion of topographic information comprising horizontal x coordinates and vertical y coordinates and including a portion corresponding to a path that a traveler is capable of traveling, comprising: a) maintaining a data structure of topographic information; b) selecting from the data structure a portion of the topographic information for display dependent on a current position of the traveler; c) receiving a specification of the behavior of the transform for large values of the y coordinate, wherein the transform comprises transformed x coordinates X and transformed y coordinates Y; d) receiving a specification of the vertical curves defined by the transformed coordinates X as a function of y for constant values of x; and e) receiving a specification of the horizontal curves defined by the transformed coordinates Y as a function of x for constant values of y, wherein the transformed set of x coordinates X and the transformed set of y coordinates Y are determined by the decoupled set of equations:
\overline{y}=h(y),
X=F(x, y)=xƒ(\overline{y}),
Y=G(x,y)=\overline{y}g(X),
wherein a variable \overline{y} describes the compression of the y axis by the function h(y) wherein ƒ\overline{y}is a scaling factor used to obtain X from x and controlling the shape of vertical curves defined by the transformed x coordinates for constant values of y, and wherein g(X) is a scaling factor used to obtain Y from \overline{y} and controlling the shape of horizontal curves defined by the transformed y coordinates for constant values of x;f) creating a transform configured so as to be consistent with the specified set of transformed y coordinates Y, with the transform behavior for large values of the y coordinate, and with the specified set of transformed x coordinates X;g) performing a coordinate transformation of the selected topographic information to represent the selected information as a variable-scale map other than a perspective map comprising transformed x coordinates X and transformed y coordinates Y; and h) displaying the selected transformed topographic information as a non-perspective variable-scale image.

According to still other embodiments of the invention, a method is disclosed for the non-perspective variable-scale display of a portion of topographic information including a portion corresponding to a path that a traveler is capable of traveling, comprising: a) maintaining a data structure of topographic information; b) selecting from the data structure a portion of the topographic information for display dependent on a current position of the traveler; c) performing a coordinate transformation of the selected topographic information to represent the selected information as a variable-scale map other than a perspective map, wherein the transform comprises a set of one or more bubble transforms, wherein each bubble transform creates one bubble, wherein each bubble is configured to magnify the scale of an area of high interest on the map while continuous map topology is maintained, and wherein each of the one or more bubbles are configured so as not to overlap any of the other bubbles; and d) displaying the selected transformed topographic information as a non-perspective variable-scale image.

According to still further embodiments of the invention a method is disclosed for, in a computer, the non-perspective variable-scale display of a portion of topographic information including a portion corresponding to a path that a traveler is capable of traveling, comprising: a) specifying, by the user of the computer, a data structure of topographic information from which the displayed information will be selected; b) receiving, by the user, a portion of the topographic information selected from the data structure for display dependent on a current position of the traveler; c) initiating, by the user, a coordinate transformation of the selected topographic information to represent the selected information as a variable-scale map other than a perspective map; and d) initiating, by the user, the display of the map as a non-perspective variable-scale image.

According to other embodiments of the invention, a machine-readable medium is disclosed, including operations stored thereon that, when processed by one or more processors, causes a system to perform the steps of: a) maintaining a data structure of topographic information; b) selecting from the data structure a portion of the topographic information for display dependent on a current position of the traveler; c) performing a coordinate transformation of the selected topographic information to represent the selected information as a variable-scale map other than a perspective map; and d) displaying the selected transformed topographic information as a non-perspective variable-scale image.

According to further embodiments of the invention, a method is disclosed for the non-perspective variable-scale display of a portion of topographic information of the surface of the earth including a surface portion on which a vehicle is capable of traveling, comprising: a) maintaining a data structure of topographic information; b) selecting from the data structure a portion of the topographic information for display dependent on a current position of the vehicle on the surface portion; c) performing a coordinate transformation of the selected topographic information to represent the selected information as a variable-scale map other than a perspective map; and d) displaying within the vehicle the selected transformed topographic information as a non-perspective image variable-scale image, wherein the vehicle travels on the surface of the earth.

According to still other embodiments of the invention, an apparatus is disclosed for non-perspective variable-scale topographic display of successive images in relation to the position of a vehicle on a surface comprising: a memory for the storage of topographic coordinate information, means for the determination of the position of the vehicle on the surface, first selection means for selecting, on the basis of the position of the vehicle, topographic sub-information from the topographic information by performing at least a first selection operation, transformation means for performing a coordinate transformation on the selected sub-information, and display means for the display of a non-perspective variable-scale image produced by the transformation, wherein the vehicle travels on the surface of the earth.

According to yet another embodiment of the invention, an apparatus is disclosed for the continuous non-perspective variable scale map that uses a continuous transform across the entire map that is not dependent on data elements for setting scale and thereby does not introduce discontinuities that would effect the spatial judgment of the driver.

### BRIEF DESCRIPTION OF THE DRAWINGS

FIG. 1A is a planar map of a city.

FIG. 1B is a schematic of a planar map.

FIG. 2A is a perspective map of a city.

FIG. 2B is a schematic of a perspective map.

FIG. 3 is a map of part of a city magnified with a variable-scale bubble.

FIG. 4 is a schematic of stages of variable-scale map design.

FIG. 5 is a map of a city/region with exponential view with horizon and linear verticals.

FIG. 6 is a map of a city/region with exponential view with concave verticals and curved horizontal.

FIG. 7 is a map of a city/region with power view with straight verticals lines and no curvature.

FIG. 8 is a map of a city/region with logarithmic view.

FIG. 9 is a map of a city/region with a destination bubble superimposed on exponential view.

FIG. 10 is a map of a city with bubbles at the origin (current position) point and at the destination point.

FIG. 11 is a map of a city/region with a magnified area indicating origin and destination points in an elongated bubble.

### DETAILED DESCRIPTION OF THE INVENTION

Mathematical Form of a Generalized Variable-scale Map

The form of a generalized variable-scale map is:
X=F(x,y), Y=G(x,y), (1)
where x and y are the coordinates of the original map and X and Y are the coordinates of the transformed map. The central axis is along y and F and G can be arbitrary smooth functions.

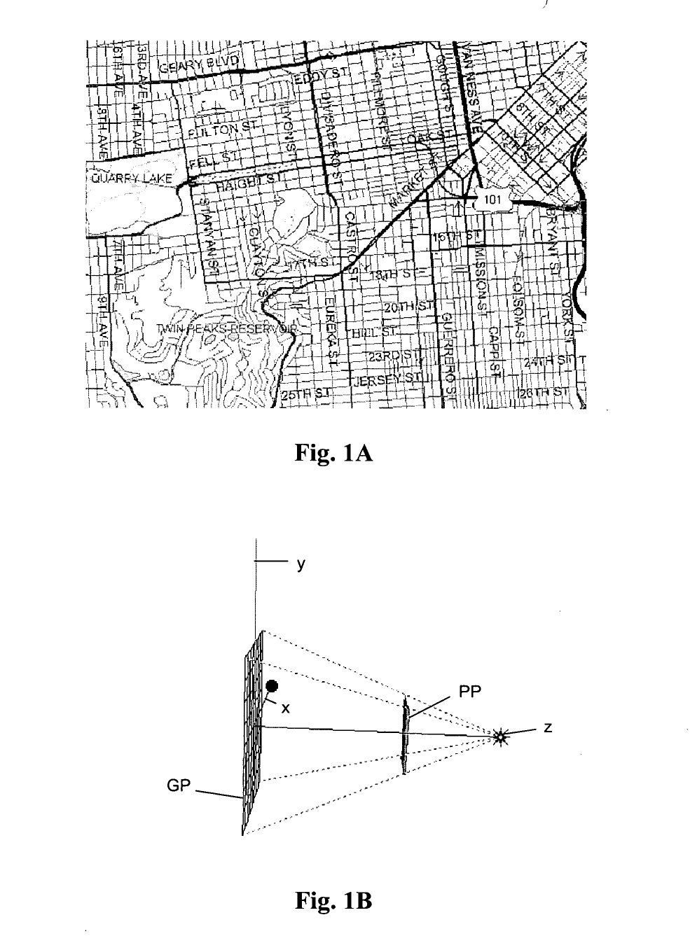

For a Planar Perspective View (see Figs. 1A, 1B) we have;
F(x,y)=kx,G(x,y)=ky, (2)
where k≦0 is a constant.

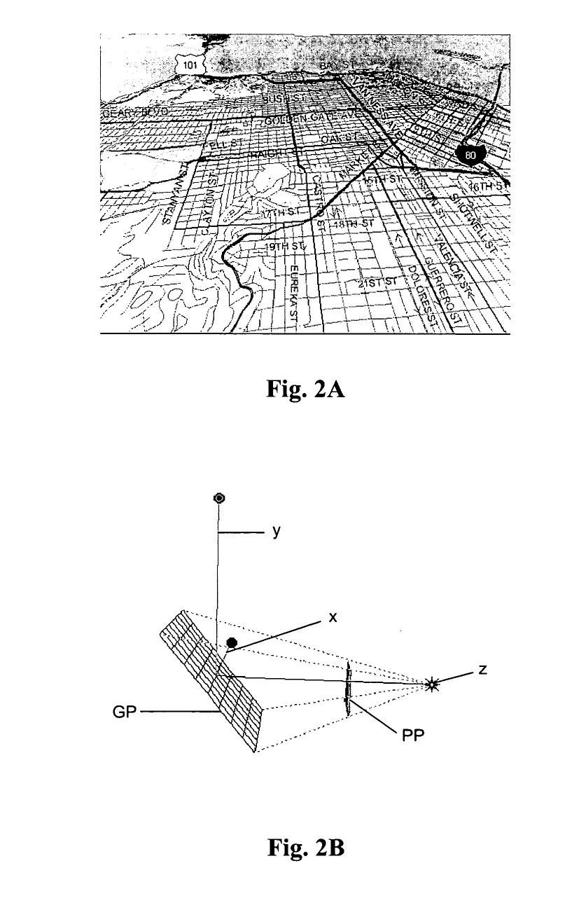

For an Angled-Perspective View (see FIG. 2A, 2B) we have:

$$X = F ( x , y ) = \frac{x {z}_{1}}{{z}_{0} - y sin α} \\ Y = G ( x , y ) = \frac{y {z}_{1} cos α}{{z}_{0} - y sin α} \qquad ( 3 )$$

where α is the angle of tilt, zo is the position of the view point on the z-axis, and z₁ is the distance between the view point and the projection plane, as seen in FIGS. 2A, 2B above.

While equation (1) is completely generalized it is somewhat difficult to deal with from a designer's point of view. Since the functions can be arbitrary there is no guideline to use in selecting an appropriate solution. At the cost of some limitation to the overall generality, a decoupled form of variable-scale equations can be defined that can be used in a simple three-stage process to design useful variable-scale maps (see FIG. 4).

Decoupled Mathematical Form of Variable-Scale Map

Consider the equations of (4) as a decoupled form of the equations of (1)
\overline{y} =h\overline{y}, F(x,y)=xƒf(\overline{y}), G(x,y)=\overline{y}g(X), (4)
where the functions and variables are defined below.

There are several advantages to this formulation, one of which is that the design can now be developed in three straight forward stages, as described below and with the aid of FIG. 4: Stage 1: Specify the behavior of the transform for large values of y. This can be done by compressing the y axis, by the function h(y), to a new variable, \overline{y}. Vertical (central axis) and horizontal (orthogonal axis) lines in the x,y-plane are transformed to vertical and horizontal lines in the x,\overline{y}-plane.

Stage 2: Specify the shape of vertical lines in the transform. X is then obtained from x by a scaling factor, f(\overline{y}). The function f is then seen to describe the shape of the transformed vertical line x=1. All other vertical lines in the x,\overline{y}-plane are scaled accordingly. Thus, ƒ controls the shape of vertical lines. Stage 3: Specify the shape of horizontal lines in the transform. The final Y value is obtained from \overline{y} by a scaling factor g(X) . The function g is then seen to describe the shape of the transformed horizontal line \overline{y}=1. All other horizontal lines in the X,\overline{y}-plane are scaled accordingly. Thus, g controls the shape of horizontal lines.

This three-step design process can more easily handle singularities as long as the designer takes care not to use equations (3) to perform a perspective transform. For example, in the angle-perspective transform, points beneath the view position would result in division by zero, which is difficult to deal with. This condition is more easily handled by the functions h and ƒ, each concerned with only a single variable.

When the first stage of the transform has a horizon, say at M, so that \overline{y}<M, we need only define ƒ \overline{y}for 0≦\overline{y}≦M. We can assume the x-axis is the bottom of the screen and is not scaled, that is ƒ(0)=1. This says that the x-axis is not stretched by ƒ . In the second stage we may wish that vertical lines converge to a single point on the horizon line, that is ƒ (M)=0. The simplest case is a straight line
ƒ \overline{y}=(M−\overline{y})/M. (5)

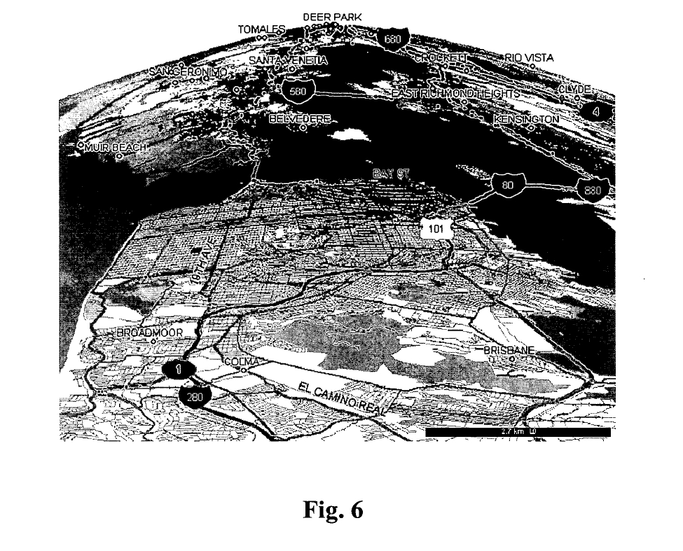

If a concave shape is desired in conjunction with stage 3 as described below, the designer can create the effect of a map of a curved surface (see FIG. 6). Any of these shapes can easily be defined as a piece-wise linear curve with the appropriate end conditions.

Also, certain visual effects are easily achieved using this method. For example, the simplest form for the function g is g(X)=1, in which case g has no effect on the transform. More interesting is a curved horizontal line such as:

$$g ( X ) = \frac{1}{1 + β {X}^{2}} \qquad ( 6 )$$

Points near the y axis are mostly unchanged, but for points further away, the horizontal lines curve downward, so the effect is to simulate a curved surface, such as the surface of the earth, but in a more exaggerated manner, thus enhancing the sense of viewing a large area.

Three useful examples of the decoupled variable-scale map will be briefly described.

### EXAMPLE 1

### The “Exponential” Variable-scale Map

The “Exponential” View as formulated by equations (7) below, has been found to have useful display characteristics, especially if a horizon is desired.
\overline{y}=k(1−e^{λy}). F(x,y)=xƒ(\overline{y}) G(x,y)=\overline{y}g(X) (7)
where λ and k are suitable constants.

Again, assume the x axis is the bottom of the map display. In the Exponential View, y is a function of y, where y is in the exponent of e. If 0<λ<1, then for large y the exponent approaches zero and what is left is a horizon, M, where M=k. The coefficient λ controls the speed at which the y axis is compressed and k sets the height of the horizon on the display. A straight line or a concave shape can be used to define ƒ(\overline{y}) as was described earlier.

### EXAMPLE 2

### The “Power” Variable-scale Map. The Power View as formulated in (8) below, also has useful display characteristics, especially if no horizon is desired.

\overline{y}=(αy+k)^{λ}−k^{λ},
F(x,y)=xƒ(\overline{y}),
G(x,y)=\overline{y}g(X), (8)
where α, λ, and k are suitable constants.

As before, assume the x axis is the bottom of the map display. In the Power View, \overline{y} is a function of y raised to a power, λ,. Take 0<λ<1, and k is chosen to be a point away from 0, typically near the point where the power function y^{λ} has slope 1, k=λ_{80 /(1-λ)}. The constant α will then have a stretching or shrinking effect.

The power function has no horizon (the y values have no upper limit) except to the extent that the map itself has a limit or the designer imposes a limit. Because there is no horizon there is no vanishing point. The shape of the vertical lines can thus be defined as

$$f ( \overline{y} ) = \frac{b}{b + \overline{y}} . \qquad ( 9 )$$

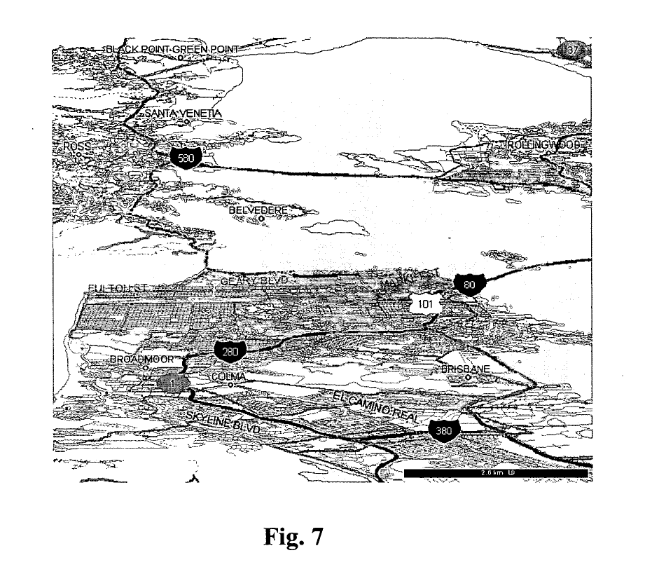

If the map is assumed to be bounded by \overline{y}<M, then we could also use a straight line or a concave shape as described above to define the shape of the vertical lines. FIG. 7 shows a power view with straight verticals sloped as in equation (9).

The power form does not have a horizon. This results in less compression for larger values of y (distance). Depending on what is to be shown, this may produce superior results.

### EXAMPLE 3

### The “Logarithmic” Variable-scale Map

The Logarithmic View is formulated in (10) below.
\overline{y}=λ log(αy+k)−log(k),
F(x,y)=xƒ(\overline{y}),
G(x,y)=\overline{y}g(X), (10)
where α, 80 , and k are suitable constants.

As before, assume the x axis is the bottom of the map display. In the logarithmic view, \overline{y} is a logarithmic function of y. Take 0<λ and k is chosen to be a point away from 0, typically near the point where the power function λlog(\overline{y}) has slope 1, k=λ. The constant a will then have a stretching or shrinking effect.

Similar to the power function, the logarithmic function has no horizon (they values have no upper limit) except to the extent that the map itself has a limit or the designer imposes a limit. Because there is no horizon there is no vanishing point. The shape of the vertical lines can thus be defined as

$$f ( \overline{y} ) = \frac{b}{b + \overline{y}} . \qquad ( 11 )$$

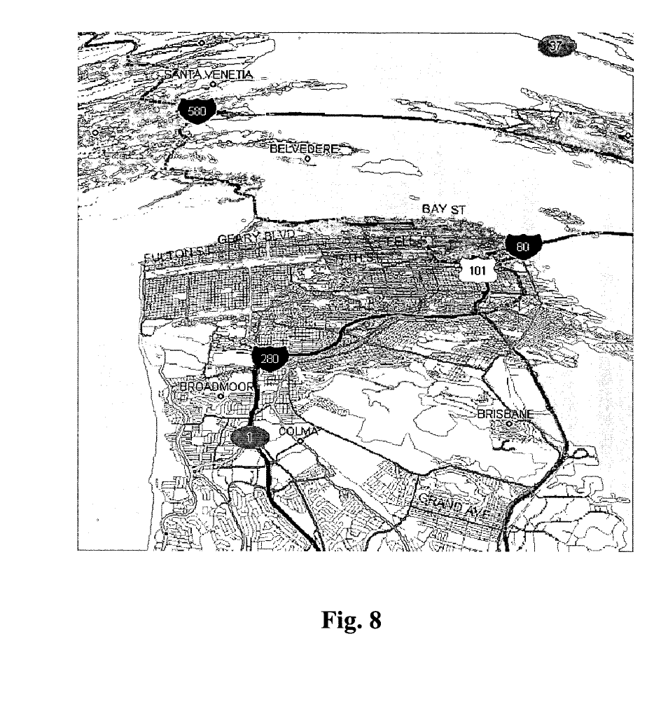

If the map is bounded by \overline{y}<M, then a straight line or a concave shape can be used as described above to define the shape of the vertical lines. FIG. 8 shows a logarithmic view with concave vertical lines and curved horizontal lines.

Finally we note that while our examples have used well-known mathematical functions, in general the finctions h, ƒ, and g can be easily implemented using table lookup and interpolation methods. This allows an implementation to achieve maximum efficiency, and allows easy modifications of the functions for a specific need, without requiring close-form algebraic expressions.

### Other Forms of Non-Perspective Variable-Scale Map—Magnifying Bubbles

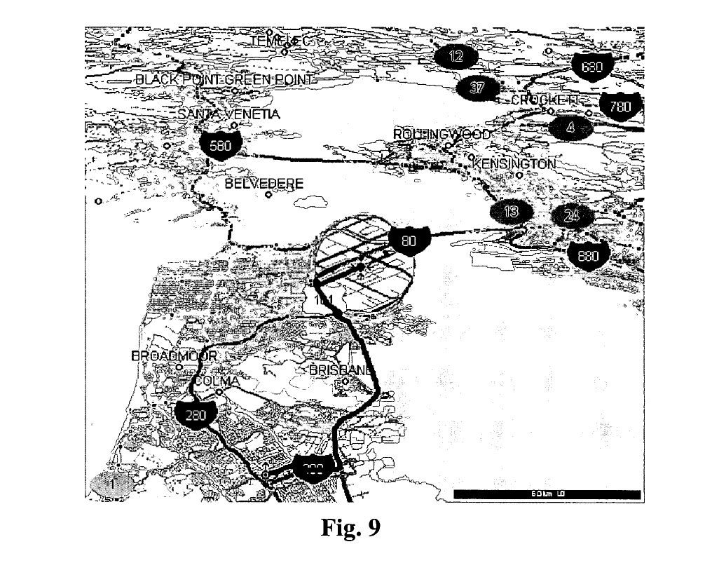

One other form of a variable-scale function is a local transformation covering only part of a map. In Harrie, L. et al. “A variable-scale map for small-display cartography,” Proceedings of the Joint International Symposium on GeoSpatial Theory Processing and Applications, (ISPRS/Commission IV, SDH2002), Ottawa, Canada, Jul. 8-12, 2002 (Harrie), a magnified area is proposed as a way to improve the presentation of details around the driver's immediate vicinity while still presenting a small scale overview of the entire route at distant regions. However, Harrie's approach produces distortion of the map everywhere outside the magnified area. According to the present invention, the magnified bubble has no distortion beyond a transition zone, and can be added to other views, such as the exponential view above, to give an overall impression as shown in FIG. 9. Within the magnified area, labels can be magnified and more details can be added in order to enhance the display's utility.

If the origin of the coordinate system is taken to be the center of the bubble, then the basic bubble transform is defined by a uniform scale factor K>1 within a disc of radius r<rₒ, a uniform scale of 1 outside of a disc of radius r>r₁, where r₁>Kr₀, and a smooth radial transition for r₀≦r≦r₁. This translates into
F(x,y)=h(r)x, G(x,y)=h(r)y, (12)
where r=√, \sqrt{x²+y²} and h is defined as
K,0≦r<r₀,
h(r)=1,r>r₁,
(mr+b)/r,r₀<r₀≦r≦r₁, (13)
and
m=(Kr₀−r₁)/(r₀−r₁),
b=r₁(1−m). (b 14)

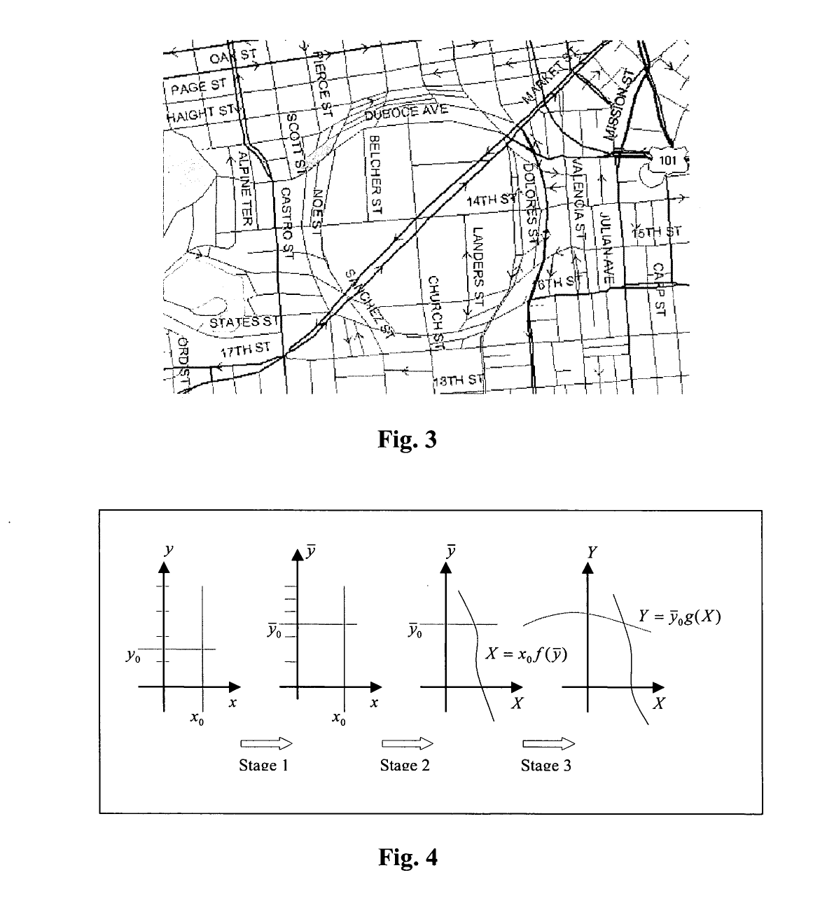

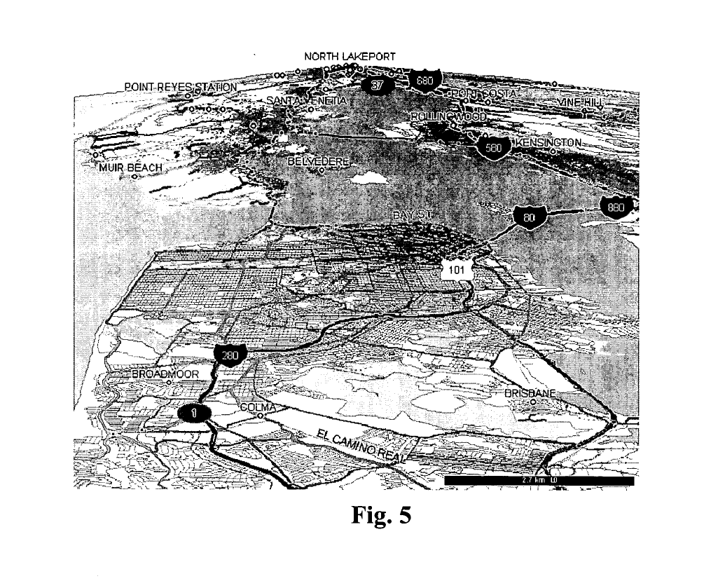

The image of this transformation will show the map with magnification factor K inside a disk of radius Kr₀, and a scale of 1 outside of disc r₁, as shown in FIG. 3. Since this transform can be applied after a global transform such as the exponential, power, or logarithmic transforms described above, the outside scale factor is multiplicative of the global variable-scale.

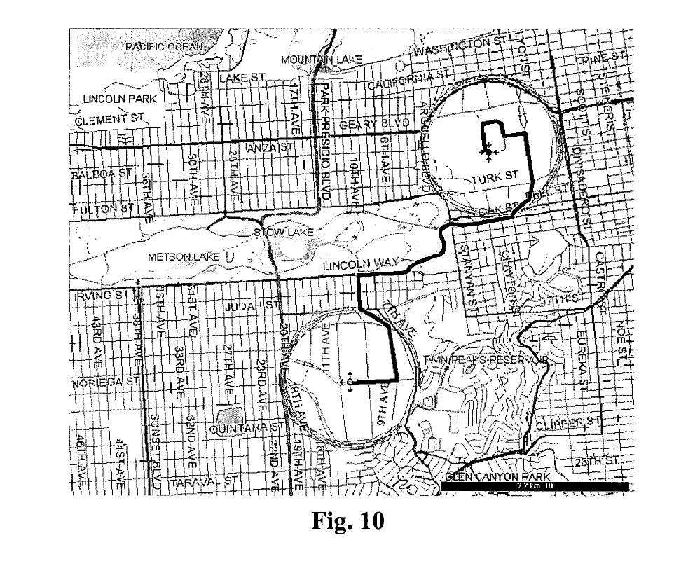

An adaptation to this bubble-scale map is the Origin-Destination Bubble Pair as shown in FIG. 10. Here the same magnifying principle is applied to the area around both the vehicle (a changing origin) and the area around the destination. These areas are typically where more detail is wanted. In general the process is not limited to just the origin and destination. Bubbles can be centered on an origin of a traveler, a current position of the traveler, a destination of the traveler, a waypoint, a maneuver along a route, a next maneuver, a point of interest, a point along a route of interest, or other areas of high interest.

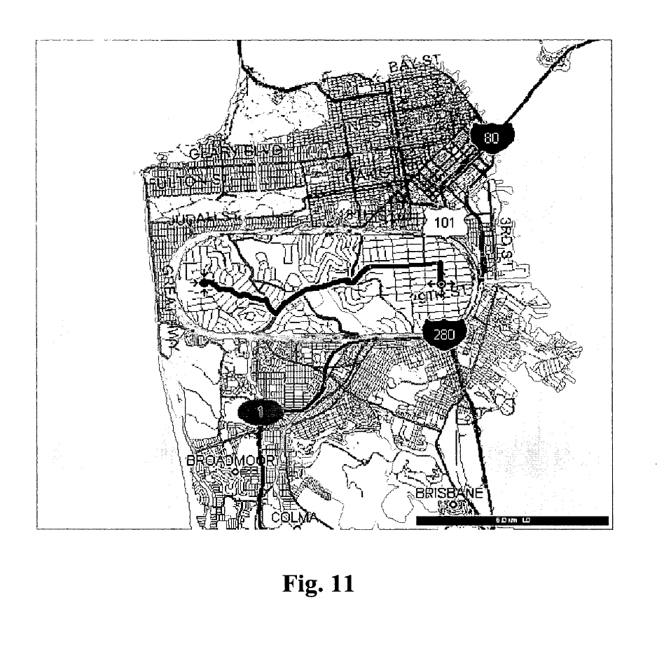

It may also be of interest to magnify the area in between important points such as origin and destination as shown in FIG. 11. The technique can be applied to a more general class of regions that are star-shaped with respect to some chosen interior point. A region is star-shaped if every radial line drawn from the chosen interior point intersects the boundary of the region on only one point. Such a region can be used as a magnified zone by using the chosen interior point as the center of the coordinate system and applying a radial distortion similar to that used for the circular disk. Star-shaped regions include all convex regions. In this more general case, r₀, and r₁ depend on x and y. Specifically r₁ is the radial distance from the chosen point to the region boundary through the point (x,y), and r₁=r₀,+d, where d is the size of the transition zone. The distance d must be chosen so that the condition, r₁>Kr₀, always holds, i.e., d>(K −1)r₀. In particular if the region is bounded radially by M, then d>(K−1)M will suffice. Equations (12)-(13) can then be applied to the star-shaped region.

### CONCLUSION

Electronic map displays, especially for in-car and handheld devices, suffer from small size. It remains an important design feature to develop navigation devices that maintain an informative and aesthetic map display format. This is particularly challenging because of the complex nature of the task involved, namely; presenting precise details in the travelers immediate vicinity, at the destination and, perhaps other points of high interest along the way, while, at the same time, presenting an overview of the entire route and general area. By judicious use of non-perspective variable-scale, the designer can fine-tune the display to be both aesthetic as well as get the critical information across to the viewer₁quickly and effectively. This disclosure concentrates on a simplified form of non-perspective variable-scale map that decouples the coordinates and allows for a straightforward three-stage design approach. In addition, the disclosure explores combining this approach with the superposition of magnifying bubbles of various numbers shapes and sizes to bring out extra detail in areas of particular importance to the traveler.

The in-car and/or handheld devices will include a memory for storing a digital map database of topological coordinate information, a selective system enabling or performing the selection of topographic sub-information of all the topological information stored in the memory, transformation software for performing a coordinate transformation of the selected sub-information, and a display for displaying a non-perspective variable scale image or map produced by the transformation such as is shown by the various map illustrations in the figures. The selection of the topographic sub-information may be accomplished based on the current position of a car or vehicle or by a user of a handheld device.

What is claimed is:

1. A method for the non-perspective variable-scale display of a portion of topographic information, comprising:
a) maintaining a data structure of topographic information;
b) selecting from said data structure a portion of the topographic information for display;
c) performing a coordinate transformation of said selected topographic information to represent said selected information as a variable-scale map other than a perspective map; and
d) displaying said selected transformed topographic information as a non-perspective variable-scale image.

2. The method of claim 1, wherein said coordinate transformation transforms a constant-scale display comprising horizontal x coordinates and vertical y coordinates into a variable-scale display other than a perspective display comprising transformed x coordinates X and transformed y coordinates Y.

3. The method of claim 2, comprising the steps of:
a) receiving a constant-scale display to be transformed by a transform into a non-perspective variable-scale display;
b) receiving a specification of the behavior of the transform for large values of the y coordinate;
c) receiving specifications of the vertical lines defined by the transformed coordinates X as a function of y for constant values of x;
d) receiving specifications of the horizontal lines defined by the transformed coordinates Y as a function of x for constant values of y; and
e) creating a display transform configured so as to be consistent with said specified set of transformed y coordinates Y, with said transform behavior for large values of the y coordinate, and with said specified set of transformed x coordinates X.

4. The method of claim 2, wherein the vertical lines defined by the transformed x coordinates for constant values of y are curved so as to create the effect of a map on a curved earth.

5. The method of claim 2, wherein the horizontal curves defined by the transformed y coordinates for constant values of x are curved so as to create the effect of a map on a curved earth.

6. The method of claim 1, wherein the transformed coordinates define a horizon.

7. The method of claim 1, wherein the transformed coordinates do not define a horizon.

8. The method of claim 2, wherein the vertical curves defined by the transformed x coordinates meet at a vanishing point.

9. The method of claim 2, wherein the vertical curves defined by the transformed x coordinates do not meet at a vanishing point.

10. The method of claim 2, wherein the transformed set of x coordinates X and the transformed set of y coordinates Y are determined by the decoupled set of equations:
\overline{y},=h(y),
X=F(x,y)=xƒ(\overline{y}),
Y=G(x,y)=\overline{y}g(X),
wherein a variable y describes the compression of the y axis by the function h\overline{y}wherein f\overline{y}is a scaling factor used to obtain X from x and controlling the shape of vertical curves defined by the transformed X coordinates for constant values of x, and wherein g(X) is a scaling factor used to obtain Y from \overline{y} and controlling the shape of horizontal curves defined by the transformed Y coordinates for constant values of y.

11. The method of claim 10, wherein g(X) describes a piecewise linear curve.

12. The method of claim 10, where g(X)=1 .

13. The method of claim 12, wherein g has no effect on the transform.

14. The method of claim 10, wherein ƒ(\overline{y}) describes a piecewise linear curve.

15. The method of claim 10, wherein ƒ\overline{y}describes straight lines.

16. The method of claim 10, wherein ƒ\overline{y}=(M−\overline{y})/M.

17. The method of claim 15, wherein the straight lines meet at a vanishing point.

18. The method of claim 10, wherein ƒ(\overline{y}) describes a set of concave curves.

19. The method of claim 18, wherein the concave curves meet at a vanishing point.

20. The method of claim 1, wherein the transform makes use of at least one of a table lookup and interpolation between values obtained through a table lookup.

21. The method of claim 20, wherein a function used to create said table is a scale compression function.

22. The method of claim 20, wherein the scale compression function is an exponential function.

23. The method of claim 20, wherein the scale compression function is a power function.

24. The method of claim 20, wherein the scale compression function is an logarithmic function.

25. The method of claim 1, wherein the transform is a scale compression function.

26. The method of claim 25, wherein the scale compression function does not have a horizon.

27. The method of claim 25, wherein the scale compression function does have a horizon.

28. The method of claim 25, wherein the scale compression function is configured to handle singularities.

29. The method of claim 2, wherein the vertical curves defined by the transformed X coordinates for constant values of x meet at a vanishing point.

30. The method of claim 2, wherein the vertical curves defined by the transformed X coordinates for constant values of x do not meet at a vanishing point.

31. The method of claim 25, wherein the scale compression function is an exponential function.

32. The method of claim 25, wherein the scale compression function is a power function.

33. The method of claim 25, wherein the scale compression function is an logarithmic function.

34. The method of claim 31, wherein the transform describing the exponential function is:
\overline{y}=k(1−e^{λy}),
X F(x,y)=xƒ(\overline{y}),
Y=G(x,y)=\overline{y}g(X),
wherein X and k are suitable constants.

35. The method of claim 34, where g(X)=1.

36. The method of claim 35, wherein g has no effect on the transform.

37. The method of claim 34, wherein horizontal curves defined by the transformed X coordinates for constant values of x are created according to the equation:
$$X = g ( X ) = \frac{1}{1 + β {X}^{2}}$$

38. The method of claim 37, wherein points near the y axis are mostly unchanged by the transform, and wherein for points further away from the y axis, the horizontal lines curve downward.

39. The method of claim 38, wherein said display simulates a curved surface in an exaggerated manner.

40. The method of claim 38, wherein said display enhances the sense of viewing a large area.

41. The method of claim 38, wherein said display facilitates seeing details in the foreground while showing the overall landscape in the background.

42. The method of claim 34, wherein 0<λ<1.

43. The method of claim 34, wherein for large y, \overline{y}=k.

44. The method of claim 34, wherein the map has a horizon, M, wherein M=k.

45. The method of claim 34, wherein the vertical curves defined by the transformed x coordinates do meet at a vanishing point.

46. The method of claim 34, wherein ƒ(\overline{y}) is defined only for 0≦\overline{y}≦M.

47. The method of claim 46, wherein ƒ(0)=1.

48. The method of claim 34, wherein the x axis is at the bottom of the map and is not scaled or stretched by ƒ.

49. The method of claim 31, wherein ƒ(M)=0, such that vertical curves defined by the transformed X coordinates for constant values of x meet at a vanishing point.

50. The method of claim 34, wherein a simple straight line is described by the equation
ƒ\overline{y}=(M−\overline{y})M/.

51. The method of claim 32, wherein the transform describing the power function is:
\overline{y}=(αy+k)^{λ}−k^{λ},
X=F(x,y)=xƒ(\overline{y}),
Y=G(x,y)=\overline{y}g(X),
where α, λ, and k are suitable constants.

52. The method of claim 51, wherein 0<λ<1.

53. The method of claim 51, wherein the vertical curves defined by the transformed X coordinates for constant values of x are created according to the equation:
$$f ( \overline{y} ) = \frac{b}{b + \overline{y}} .$$

54. The method of claim 51, wherein the vertical curves defined by the transformed X coordinates for constant values of x are one of approximately straight lines and exactly straight lines.

55. The method of claim 51, wherein each of the vertical curves defined by the transformed x coordinates for constant values of y has a concave shape.

56. The method of claim 51, wherein the x axis is the bottom of the map.

57. The method of claim 51, wherein k is a point away from 0, typically near the point where the power function y⁸⁰ has slope 1, such that k =

58. The method of claim 51, wherein the constant a has one of a stretching effect and a shrinking effect.

59. The method of claim 51, wherein the magnitude of y can be arbitrary large, such that there is no horizon.

60. The method of claim 51, wherein the magnitude of y is limited to a maximum M.

61. The method of claim 60, wherein the magnitude of \overline{y} is limited by an inherent limit of the map.

62. The method of claim 60, wherein the magnitude of \overline{y} has a limit M imposed.

63. The method of claim 33, wherein the transform describing the logarithmic function is:
\overline{y}=λ log(αy+k)−log(k),
F(x,y)=xƒ(\overline{y}),
G(x,y)=\overline{y}g(X),
where α, λ, and k are suitable constants.

64. The method of claim 60, wherein 0 <λ

65. The method of claim 60, wherein the vertical curves defined by the transformed x coordinates for constant values of y are created according to the equation:
$$f ( \overline{y} ) = \frac{b}{b + \overline{y}} .$$

66. The method of claim 63, wherein the vertical curves defined by the transformed X coordinates for constant values of x are one of approximately straight lines and exactly straight lines.

67. The method of claim 63, wherein each of the vertical curves defined by the transformed X coordinates for constant values of x has a concave shape.

68. The method of claim 63, wherein the x axis is the bottom of the map.

69. The method of claim 63, wherein k is a point away from 0, typically near the point where the power function λ log y has slope 1, such that k=λ

70. The method of claim 63, wherein the constant a has one of a stretching effect and a shrinking effect.

71. The method of claim 63, wherein the magnitude of \overline{y} can be arbitrarily large, such that there is no horizon.

72. The method of claim 63, wherein the magnitude of \overline{y} is limited to a maximum M.

73. The method of claim 72, wherein the magnitude of \overline{y} is limited by an inherent limit of the map.

74. The method of claim 72, wherein the magnitude of \overline{y} has a limit M imposed.

75. The method of claim 1, wherein the transform comprises a set of one or more bubble transforms, wherein each said bubble transform creates one bubble, wherein each said bubble is configured to magnify the scale of an area of high interest on the map while continuous map topology is maintained, and wherein each of said one or more bubbles are configured so as not to overlap any of the other said bubbles.

76. The method of claim 75, wherein one or more of bubbles is a region that is star-shaped with respect to a chosen interior point.

77. The method of claim 76, wherein for each said star-shaped region, every radial line drawn from said chosen interior point intersects the boundary of said region at exactly one point.

78. The method of claim 77, wherein said chosen interior point is a center of a coordinate system for said star-shaped region, and wherein a radial distortion is applied about said chosen interior point.

79. The method of claim 78, wherein for each said bubble, the origin of a bubble coordinate system is the center of the region, and wherein the bubble transform corresponding to said bubble is defined by a uniform scale factor K>1 within an inner region comprising said bubble origin and of radius r<r₀, a uniform scale of K=1 for an outer region described by radius r>r₁, where r₁>Kr₀, and a smooth radial transition within a transition region described by r₀≦r≦r₁.

80. The method of claim 79, wherein r₀, and r₁are each functions of x and y.

81. The method of claim 80, wherein r₀,(x,y) is the radial distance from the origin to the boundary of the bubble through the point (x,y).

82. The method of claim 80, wherein r₁(x,y)=r₀,(x,y)+d, wherein d is the size of the transition region.

83. The method of claim 82, wherein d is chosen so that d>(K−1) r₀.

84. The method of claim 83, wherein the region is bounded radially by M, and wherein d>(K−1)M.

85. The method of claim 84, wherein:
X=F(X,Y)=h(r)x,
Y=G(X, Y)=h(r)y
wherein r=\sqrt{x²+y²}, and wherein h is defined by:
K,0≦r<r₀,
h(r)=1,r>r₁,
(mr+b)/r,r₀,≦r≦r₁,

86. The method of claim 79, wherein r₀, and r₁are each constants, such that said inner region, said transition region, and said outer region are each concentric circles.

87. The method of claim 86, wherein the bubble transform magnifies the map by a magnification factor K inside a disk of radius Kr₀, and by a magnification factor I outside of disc r₁.

88. The method of claim 86, wherein the bubble transform is described by:
X=F(X,Y)=h(r)x,
Y=G(X,Y)=h(r)y
wherein r+\sqrt{x²+y²}, and wherein h is defined by:
K,r≦r<r₁,
h(r)=1,r>r₁,
(mr+b)/r,r₀r₁ ,
and
m=(Kr₀, −r₁)/(r₀ −r₁),
b=r₁(1−m).

89. The method of claim 75, wherein at least one of said one or more bubbles comprises one or more areas of high interest, wherein a area of high interest comprises one or more of an origin of a traveler, a current position of the traveler, a destination of the traveler, a waypoint, a maneuver along a route, a next maneuver, a point of interest, and a point along a route of interest.

90. The method of claim 75, wherein at least one of said one or more bubbles is centered about a area of high interest, wherein a area of high interest comprises one or more of an origin of a traveler, a current position of the traveler, a destination of the traveler, a waypoint, a maneuver along a route, a next maneuver, a point of interest, and a point along a route of interest.

91. The method of claim 75, wherein said one or more bubbles are superimposed on a map that is constant in scale.

92. The method of claim 75, wherein said one or more bubbles are superimposed on a background map that has undergone a background transform.

93. The method of claim 92, wherein said background transform is an exponential transform.

94. The method of claim 92, wherein said background transform is a power transform.

95. The method of claim 92, wherein said background transform is a logarithmic transform.

96. The method of claim 75, wherein at least one of said one or more bubbles has a constant scale internal to said bubble.

97. The method of claim 75, wherein said map has a constant scale external to said one or more bubbles.

98. The method of claim 75, wherein the size of at least one of the one or more bubbles is adjustable.

99. The method of claim 75, wherein the scale of at least one of the one or more bubbles is adjustable.

100. The method of claim 75, wherein the transform further creates a transition region between points just inside each of said one or more bubbles and adjacent points just outside each of said one or more bubbles.

101. The method of claim 100, wherein the transition region is configured so that the topology of the map is continuous.

102. The method of claim 100, wherein the transition region is configured so that features that cross the transition region are continuous.

103. The method of claim 100, wherein the transition region has a linear rate of change of scale in the radial direction.

104. The method of claim 100, wherein the depth of the transition region is adjustable.

105. The method of claim 100, wherein one bubble surrounds an origin of a traveler.

106. The method of claim 75, wherein one bubble surrounds a destination of a traveler.

107. The method of claim 75, wherein a bubble surrounds a current position of a traveler.

108. The method of claim 107, wherein said current position bubble moves as the position of the traveler changes, such that the current position bubble remains centered on the traveler.

109. The method of claim 108, wherein said displayed image is configured such that the current position of the traveler is shown at the center of the display.

110. The method of claim 109, wherein said displayed image is configured to move such that the current position of the traveler remains at the center of the display.

111. The method of claim 75, wherein each of said one or more bubbles has an independently adjustable scale.

112. The method of claim 75, wherein at least one of said one or more bubbles comprises at least one non-geographic object.

113. The method of claim 112, wherein said non-geographic objects comprise labels, icons, and other non-geographic objects.

114. The method of claim 112, wherein non-geographic objects within at least one of the one or more bubbles are magnified.

115. The method of claim 75, wherein non-geographic objects within at least one of the one or more bubbles are not magnified.

116. The method of claim 75, wherein the transform further creates a connecting region, wherein said connecting region connects two or more areas of high interest, and wherein the scale of said connecting region is magnified.

117. The method of claim 116, wherein said bubbles and said connecting region are both consistent with a region that is star-shaped with respect to a chosen interior point.

118. The method of claim 117, wherein said connecting region has a linear configuration.

119. The method of claim 75, wherein at least one of the said one or more bubbles has a generally circular shape.

120. An apparatus for non-perspective variable-scale topographic display of successive images comprising: a memory for the storage of topographic coordinate information, first selection means for selecting topographic sub-information from the topographic information by performing at least a first selection operation, transformation means for performing a coordinate transformation on the selected sub-information, and display means for the display of a non-perspective variable-scale image produced by the transformation.

121. A method for the non-perspective variable-scale display of a portion of topographic information including a portion corresponding to a path that a vehicle is capable of traveling, comprising:
a) maintaining a data structure of topographic information;
b) selecting from said data structure a portion of the topographic information for display dependent on a current position of the vehicle;
c) performing a coordinate transformation of said selected topographic information to represent said selected information as a variable-scale map other than a perspective map; and
d) displaying said selected transformed topographic information as a non-perspective variable-scale image.

122. A method for the non-perspective variable-scale display of a portion of topographic information comprising horizontal x coordinates and vertical y coordinates and including a portion corresponding to a path that a traveler is capable of traveling, comprising:
a) maintaining a data structure of topographic information;
b) selecting from said data structure a portion of the topographic information for display dependent on a current position of the traveler;
c) receiving a specification of the behavior of the transform for large values of the y coordinate, wherein said transform comprises transformed x coordinates X and transformed y coordinates Y;
d) receiving a specification of the vertical curves defined by the transformed coordinates X as a function of y for constant values of x; and
e) receiving a specification of the horizontal curves defined by the transformed coordinates Y as a function of x for constant values of y, wherein the transformed set of x coordinates X and the transformed set of y coordinates Y are determined by the decoupled set of equations:
\overline{y}=h(y),
X=F(x,y)=xƒ(\overline{y}),
Y=G(x,y) \overline{y}g(X),
wherein a variable \overline{y} describes the compression of the y axis by the function h(y), wherein ƒ(\overline{y}) is a scaling factor used to obtain X from x and controlling the shape of vertical curves defined by the transformed X coordinates for constant values of x, and wherein g(X) is a scaling factor used to obtain Y from \overline{y} and controlling the shape of horizontal curves defined by the transformed Y coordinates for constant values of y;
f) creating a transform configured so as to be consistent with said specified set of transformed y coordinates Y, with said transform behavior for large values of the y coordinate, and with said specified set of transformed x coordinates X;
g) performing a coordinate transformation of said selected topographic information to represent said selected information as a variable-scale map other than a perspective map comprising transformed x coordinates X and transformed y coordinates Y; and
h) displaying said selected transformed topographic information as a non-perspective variable-scale image.

123. The method of claim 122, wherein the transform is described by the exponential function:
\overline{y}=k(1−e^{-λy}),
X=F(x,y)=xƒ(\overline{y}),
Y=G(x,y)=\overline{y}g(X)
wherein λ and k are suitable constants.

124. The method of claim 122, wherein the transform is described by the exponential function:
\overline{y}=k(1−e^{-λy}),
X=F(x,y)=xƒ(\overline{y}),
Y=G(x,y)=\overline{y}g(X)
wherein λ and k are suitable constants.

125. The method of claim 122, wherein the transform is described by the exponential function:
\overline{y}=k(1−e^{-λy}),
X=F(x,y)=xƒ(\overline{y}),
Y=G(x,y)=\overline{y}g(X)
wherein λ and k are suitable constants.

126. The method of claim 122, wherein the transform is configured to have well- defined behavior at all map locations.

127. The method of claim 126, wherein said map locations include map locations that may not be visible in the map display.

128. A method for the non-perspective variable-scale display of a portion of topographic information including a portion corresponding to a path that a traveler is capable of traveling, comprising:
a) maintaining a data structure of topographic information;
b) selecting from said data structure a portion of the topographic information for display dependent on a current position of the traveler;
c) performing a coordinate transformation of said selected topographic information to represent said selected information as a variable-scale map other than a perspective map, wherein the transform comprises a set of one or more bubble transforms, wherein each said bubble transform creates one bubble, wherein each said bubble is configured to magnify the scale of an area of high interest on the map while continuous map topology is maintained, and wherein each of said one or more bubbles are configured so as not to overlap any of the other said bubbles; and
d) displaying said selected transformed topographic information as a non-perspective variable-scale image.

129. In a computer, a method for the non-perspective variable-scale display of a portion of topographic information including a portion corresponding to a path that a traveler is capable of traveling, comprising:
a) specifying, by the user of the computer, a data structure of topographic information from which the displayed information will be selected;
b) receiving, by the user, a portion of the topographic information selected from said data structure for display dependent on a current position of the traveler;
c) initiating, by the user, a coordinate transformation of said selected topographic information to represent said selected information as a variable-scale map other than a perspective map; and
d) initiating, by the user, the display of said map as a non-perspective variable-scale image.

130. The method of claim 129, further including:
c1) specifying, by the user, the behavior of the transform for large values of the y coordinate, wherein said transform comprises transformed x coordinates X and transformed y coordinates Y;
c2) specifying, by the user, the vertical curves defined by the transformed coordinates X as a function of y for constant values of x; and
c3) specifying, by the user, the horizontal curves defined by the transformed coordinates Y as a function of x for constant values of y, wherein the transformed set of x coordinates X and the transformed set of y coordinates Yare determined by the decoupled set of equations:
\overline{y}=h(y),
X=F(x,y)=xƒ(\overline{y}),
Y=G(x,y)=\overline{y}g(X),
wherein a variable \overline{y} describes the compression of the y axis by the function h(y) wherein ƒ(\overline{y}) is a scaling factor used to obtain X from x and controlling the shape of vertical curves defined by the transformed X coordinates for constant values of x, and wherein g(X) is a scaling factor used to obtain Y from \overline{y} and controlling the shape of horizontal curves defined by the transformed Y coordinates for constant values of y; and
c4) receiving, by the user, a display of the transformed non-perspective variable-scale map, wherein said transform is configured so as to be consistent with said specified set of transformed y coordinates Y, with said transform behavior for large values of the y coordinate, and with said specified set of transformed x coordinates X; and
c5) receiving, by the user, a display of the transformed variable-scale map display.

131. A machine-readable medium, including operations stored thereon that, when processed by one or more processors, causes a system to perform the steps of:
a) maintaining a data structure of topographic information;
b) selecting from said data structure a portion of the topographic information for display dependent on a current position of the traveler;
c) performing a coordinate transformation of said selected topographic information to represent said selected information as a variable-scale map other than a perspective map; and
d) displaying said selected transformed topographic information as a non-perspective variable-scale image.

132. A method for the non-perspective variable-scale display of a portion of topographic information of the surface of the earth including a surface portion on which a vehicle is capable of traveling, comprising:
a) maintaining a data structure of topographic information;
b) selecting from said data structure a portion of the topographic information for display dependent on a current position of the vehicle on said surface portion;
c) performing a coordinate transformation of said selected topographic information to represent said selected information as a variable-scale map other than a perspective map; and
d) displaying within said vehicle said selected transformed topographic information as a non-perspective image variable-scale image, wherein said vehicle travels on the surface of the earth.

133. An apparatus for non-perspective variable-scale topographic display of successive images in relation to the position of a vehicle on a surface comprising: a memory for the storage of topographic coordinate information of the surface, first selection means for selecting, on the basis of the position of the vehicle, topographic sub-infornation from the topographic information by performing at least a first selection operation, transformation means for performing a coordinate transformation on the selected sub-information, and display means for the display within the vehicle of a non-perspective variable-scale image produced by the transformation, wherein said vehicle travels on the surface of the earth.
